(19) United States
(12) Patent Application Publication
(10) Pub. No.: US 2013/0283183 A1
(43) Pub. Date: Oct. 24, 2013

(54) METHOD FOR PERSONALIZING AN APPLIANCE USER INTERFACE

(71) Applicant: Whirlpool Corporation, Benton Harbor, MI (US)

(72) Inventors: JOHN M. KNIGHT, Indianapolis, IN (US); ALI M. VASSIGH, San Jose, CA (US)

(21) Appl. No.: 13/904,422

(22) Filed: May 29, 2013

Related U.S. Application Data
(63) Continuation of application No. 11/436,080, filed on May 17, 2006, now abandoned.

(51) Int. Cl. G06F 3/01

(52) U.S. Cl. CPC G06F 3/01
USPC 715/744

(57) ABSTRACT

A method is provided for personalizing the user interface of an appliance by displaying a standard interface template. The standard interface template is based on the detected biometric characteristics of a user and the demographic class matching the set of detected biometric characteristics.

### CROSS-REFERENCE TO RELATED APPLICATION

This application is a continuation of U.S. application Ser. No. 11/436,080, filed May 17, 2006, which is incorporated herein by reference in its entirety.

### BACKGROUND OF THE INVENTION

1. Field of the Invention

The invention relates generally to a user interface for an appliance, and more specifically to a method for personalizing a user interface for an appliance.

2. Description of the Related Art

Home appliances are becoming increasingly complex as more processor-based controllers are used that permit the offering of more functions to a user to improve the performance and convenience of the home appliance. Most home appliances are provided with a user interface to program and operate the functions. To accommodate the large number of functions, some user interfaces have changeable displays that present one or more functions at a time to the user. For example, touch-screen displays can be provided on appliances that have several different menus of functions. The groups of functions are programmed by the manufacturers and force all users to conform to one predetermined user interface.

Many appliance functions require input from a user to operate. Depending on the appliance and operation, the user may have to input the time and temperature of a cooking, washing, or heating cycle, and so on. The process of initially programming these functions can be complicated and time-consuming for the user. Furthermore, many users only use a subset of functions, and it can be frustrating to step through many menus each time the user wants the appliance to perform a preferred task. For example, a user who uses the gentle wash cycle of a washing machine most often might prefer the gentle wash option to appear first on the user interface. However, the user would also want to be able to quickly and easily access other functions of the washing machine through the user interface. Different groups of users also use different features more often than other groups. For example, adults tend to use more complex features of appliances than children do.

Therefore, an appliance user interface is needed that can automatically present a personalized display of functions.

### SUMMARY OF THE INVENTION

The invention addresses the shortcomings of known user interfaces by providing a method for personalizing the operation of an appliance comprising a controller for controlling one or more functions of the appliance, a user interface operably coupled to the controller through which a user can select the one or more functions of the appliance, and at least one device that can detect a biometric characteristic of the user. The method includes establishing multiple demographic classes of users based on a set of passively identifiable biometric characteristics, establishing a standard interface template for each of the multiple demographic classes, detecting the set of biometric characteristics of an unknown user using the at least one device, matching the set of detected biometric characteristics to one of the multiple demographic classes, assigning to the user the matched demographic class, and displaying the standard interface template for the assigned demographic class on the user interface.

### BRIEF DESCRIPTION OF THE DRAWINGS

In the drawings:

FIG. 1 is a schematic of an appliance having a user interface according to the present invention.

FIG. 2 is a flow chart showing a method for personalizing the user interface from FIG. 1.

FIGS. 3A-3D are schematic illustrations of the user interface from FIG. 1 personalized for a child.

FIGS. 4A-4D are schematic illustrations of the user interface from FIG. 1 personalized for an adult.

FIG. 5 is a schematic illustration showing a refined user interface for a child.

### DESCRIPTION OF THE PREFERRED EMBODIMENT

A user interface for an appliance can be personalized according to a method of the present invention. A user approaching the appliance is identified and a user-specific interface is created based on the identification of the user. The user-specific interface allows the user to operate the functions of the appliance in a more convenient manner than a non-user-specific interface.

The term function, as used herein, describes the programs, settings, and parameters that a user can manipulate to operate the appliance. Some functions can operate the appliance by default. For example, a microwave may have a one-touch button to cook popcorn that automatically sets the cook time and heating level associated with cooking popcorn. Other functions may require input from the user to operate the appliance. For example, a general heating operation in a microwave may need the user to input the cook time and heating level for the heating operation. Still other functions can be modified over time based on the usage habits of the user. For example, if a user commonly thaws a particular food item, such as chicken, for a regular length of time, such as 10 minutes, then selection of a “DEFROST” function by the user will eventually automatically set the cook time for 10 minutes. However, the user may easily change the cook time with very few actions if a different cook time for a thawing operation is desired.

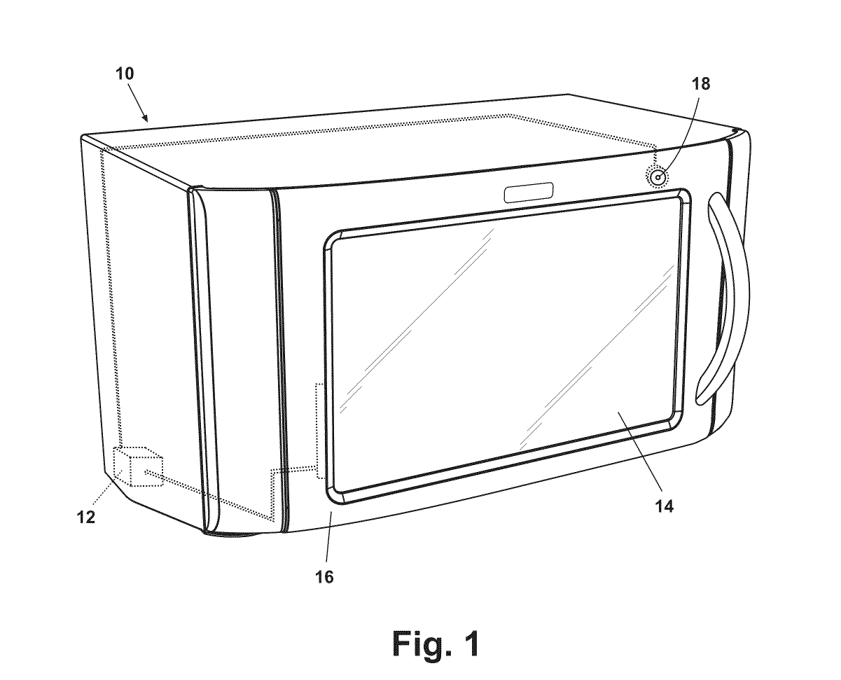

Referring now to the drawings, and particularly to FIG. 1, an appliance 10 is provided with a controller 12 for controlling the functions of the appliance 10, and a user interface 14 that is operably coupled to the controller 12 and through which a user can select the functions of the appliance 10 to effect operation of the appliance 10. The appliance 10 is illustrated as a microwave, however, it will be understood that the invention as described herein can be incorporated into any household or consumer appliance. Examples of appliances 10 that can be provided with the user interface 14 of the invention include, but are not limited to dishwashers, clothes washing machines, clothes dryers, ranges, and ovens.

The user interface 14 is positioned on the appliance 10 in a location that is convenient and easy for the user to access. For a microwave, the user interface 14 is preferably provided on the front panel of a door 16 of the microwave. The user interface 14 may comprise any known user interface. For example, the user interface 14 can optionally comprise a touch-screen monitor. Alternatively, the user interface 14 can comprise a number of buttons positioned on the perimeter of a graphic display, where the graphic display changes to provide different labels for each of the buttons.

The appliance 10 is further provided with a sensor 18 that can detect at least one biometric characteristic(s) of the user. The sensor 18 is operably coupled to the controller 12 to provide the controller 12 with the biometric information of the user. Based on the biometric characteristics detected, the sensor 18 can generate a corresponding signal that is received by the controller 12. The controller 12 then uses the detected biometric characteristics to identify the user.

The sensor 18 comprises any device that can detect a biometric characteristic of a person. Some non-limiting examples of sensors 18 include a body dimension scan, scale, facial scan, retinal scan, voice scan, speech recognition, language recognition, fingerprint scan, finger pressure sensor, finger surface area sensor, infrared scanners, radar scanners, acoustic scanners, digital cameras, and heat sensors. The type of sensor 18 is chosen based on the biometric characteristic that it detects. The biometric characteristic detectable by the sensor 18 includes, but is not limited to, height, weight, body mass, facial pattern, iris pattern, voice pattern, voice spectrum scan, speech pattern, language, handedness, fingerprint, finger pressure, finger size, and body temperature.

Preferably, the sensor 18 automatically detects multiple biometric characteristics upon the approach of the user to the appliance 10. The appliance 10 can be provided with a motion detecting device (not shown) or other suitable apparatus that will automatically prompt the sensor 18 to detect a biometric characteristic of the user when the user in within a predetermined distance of the appliance 10. Alternately, the sensor 18 can be manually prompted by the user.

The sensor 18 can be integral with the appliance 10 or can an externally located device. The position of the sensor 18 is based on the biometric characteristic it detects. For example, if the sensor 18 is used to detect a facial characteristic, it will be located at level corresponding to the face of most users. If the sensor 18 is used to detect a fingerprint, it will be located at a level corresponding to the hand of most users.

At a minimum, the sensor 18 detects one biometric characteristic of the user. Preferably, the sensor 18 is configured to detect multiple biometric characteristics of the user. Alternatively, multiple sensors 18 can be provided to each detect a different biometric characteristic of the user.

The detected biometric characteristics are used to identify the user by passive identification or active identification. In the illustrated embodiment, the user is passively identified by matching the set of detected biometric characteristics to a predetermined class stored by the controller 12. The controller 12 stores multiple predetermined classes that are based on a unique set of demographic information compiled by the manufacturers of the appliance 10. The predetermined classes can correspond to general groups of users that commonly use the same functions of the appliance 10. For example, one predetermined class can correspond to a child user, who may use the simplest functions of the appliance most often.

The demographic information can be general information, including, but not limited to, age, gender, and/or language that usually corresponds to certain biometric characteristics. For example, a user that is 10 years old might commonly have a weight ranging from 70 lbs. to 90 lbs. and a height ranging from 53″ to 57″. Thus, a user weighing 80 lbs. and who is 55″ tall would, hypothetically, be identified as being 10 years old and would be identified within the predetermined class corresponding to a child user.

Active identification of the user requires the biometric characteristics of the user to be programmed into the user interface so that the user is individually recognized based on the biometric characteristics stored by the controller for that user. For example, a fingerprint or retinal scan can be used to actively identify the user.

Each predetermined class has an associated standard interface template that is assigned to the user once the user has been identified. The standard interface template is used as the base template to create a user-specific interface on the user interface 14. The standard interface template can comprise a number of menus that present the functions of the appliance that are used most commonly by the users within the associated predetermined class; however, all the functions of the appliance are still available to the user though manipulation the user interface 14. Alternately, some predetermined classes could be denied access to certain functions of the appliance 10. For example, a child or an unknown user could have limited access to functions of the appliance 10 for safety and/or security reasons. The standard interface template can further include graphics and sounds that appeal to most users within the associated predetermined class.

The standard interface templates can, for example, comprise a child, teen, adult, older adult, and unknown user template. The child template can be assigned to users up to 12 years old, the teen template can be assigned to users aged 13-19, the adult template can be assigned to users aged 20-50, the older adult template can be assigned to users aged 50 and older, and the unknown template can be assigned to users that cannot be identified by their detected biometric characteristics. These standard interface templates are arbitrary examples, and should not be construed to limit the invention.

The controller 12 can improve the accuracy of identification with respect to an individual user by increasing or decreasing the association of a particular set of biometric characteristics with a user-specific interface. The association can be adjusted in predetermined, equal increments or any other suitable method known in the art, such as by weighting the adjustment with respect to certain functions. This allows the user interface 14 to adapt to the users who operate the appliance 10 most often, for example, the group of users in a household. When the user has been correctly identified, the controller 12 will increase the association of the set of biometric characteristics with the presented user-specific interface, for example, by one increment. A correct identification can be determined if the user begins to operate the appliance using the presented user-specific interface. When the user has been incorrectly identified, the controller will decrease the association of the set of biometric characteristics with the presented user-specific interface, for example, by one increment. An incorrect identification can be determined, for example, if the user takes a specific action such as pressing a particular button provided on the appliance 10 or user interface 14 that tells the controller 12 that the user has been incorrectly identified. Over time, the accuracy of user identification is greatly improved through continuous adjustment.

The usage habits of the identified user are also stored by the controller 12. The usage habits comprise the user's ongoing operation of the appliance 10 and can be determined by tracking the operational history of the appliance 10 with respect to a particular user. By adjusting the association of a particular set of biometric characteristics with functions that a user possessing the particular set of biometric characteristics, a refined interface template can be developed that creates a refined user-specific interface that presents the subset of appliance functions that are used most commonly by the identified user. The refined interface template can be developed by modifying the standard interface templates or by creating new interface templates. The usage habits are continuously tracked by the controller 12 so that any alteration in the user's habits over time is taken into account. Thus, the user-specific interface associated with a particular identified user is continuously updated. As described above with respect to user identification, the usage habits can be tracked by incrementally adjusting the association or by or any other suitable method.

Thus, the controller is able to develop a user-specific interface by passively and/or actively identifying demographic information for each user, selecting a standard interface template based on the demographic information, refining the standard interface over time in response to the usage habits of a specific user, and refining the identification of a user through a user profile.

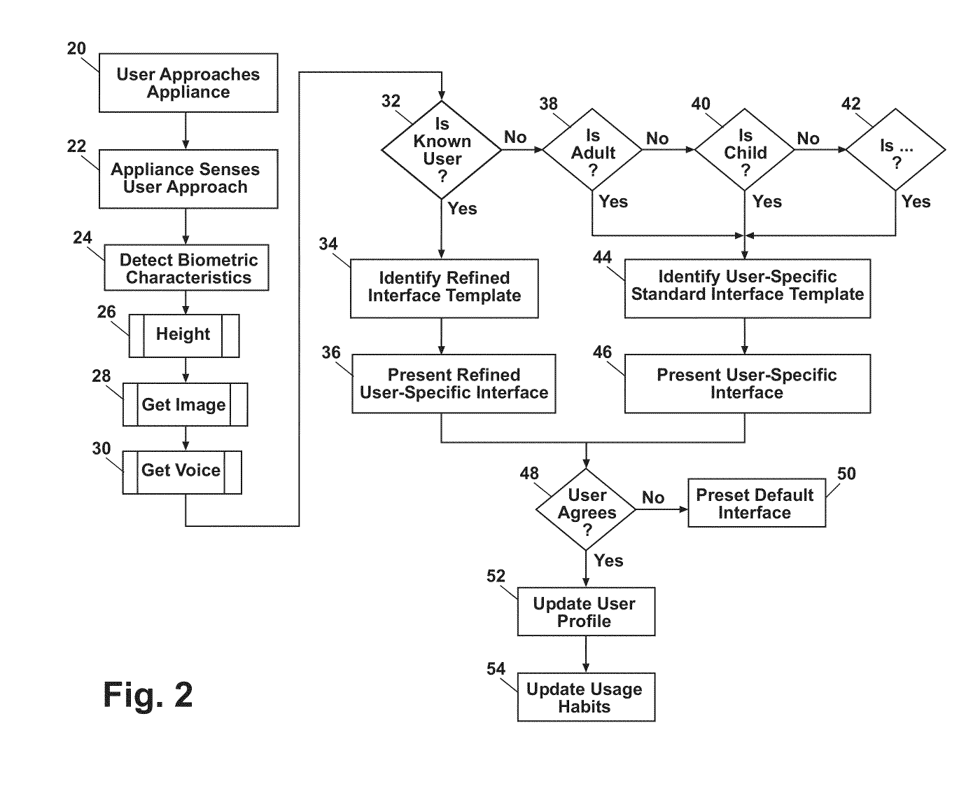

A method of personalizing an appliance user interface will now be described with reference to FIG. 2. In step 20, the user approaches the appliance 10. When the user is within a predetermined distance, the appliance 10 senses the user in step 22. The sensor 18 is prompted to detect the biometric characteristics of the user in step 24, such as height, facial shape and voice pattern. The sensor 18 may accordingly perform a height scan 26, a facial scan 28, and a voice scan 30. In step 32, the biometric data is used to determine if the user is a known user. If the user is a known user, the refined interface template for the known is assigned in step 34. In step 36, a refined user-specific interface based on the refined interface template is presented on the user interface 14.

If the user is not a known user, the user is identified by within one predetermined class, such as adult in step 38, a child in step 40, or unknown user in step 42. Once the user has been identified within a predetermined class in steps 38-40, the standard interface template for the predetermined class is assigned to the user in step 44 and a user-specific interface based on the standard interface template is presented in step 46 on the user interface 14.

Once a user-specific interface has been presented in step 36 or 46, the user can approve or disapprove of it in step 48. If the user disapproves, in step 50 a default or generic interface can be presented. Alternately, the method can loop back to step 24 and detect the biometric characteristics of the user again. If the user approves the presented user-specific interface in step 48, the profile and usage habits of the user will accordingly be updated in steps 52, 54, respectively.

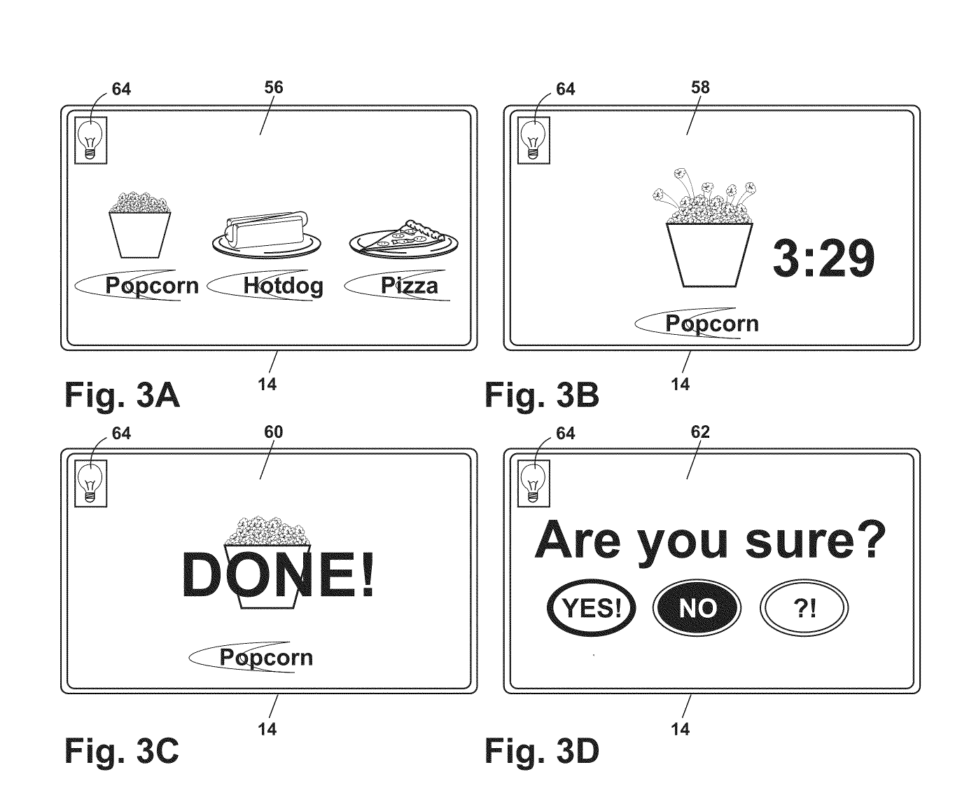

Referring to FIG. 3A-3D, an illustrative example of a child user-specific interface is presented. A user that is identified as a child will initially be presented with an option menu 56, as shown in FIG. 3A. The option menu 56 comprises the appliance functions that a child typically uses, such as heating popcorn, hotdogs, and pizza. The functions can be presented as one-touch buttons that automatically program the cook time and temperature for the child. Other menus of the child user-specific interface can be a progress menu 58 (FIG. 3B) that appears when the appliance 10 is in operation, an end menu 60 (FIG. 3C) that appears when the appliance 10 has completed an operation, and a confirmation menu 62 (FIG. 3D) that appears after the appliance 10 has completed an operation. Each menu 56-62 is provided with a help button 64 that the user can press if the user has been assigned an incorrect user-specific interface because of an incorrect identification. The user can reject the presented user-specific interface at any time by pressing the help button 64. Upon pressing the help button 64, the user interface 14 may switch to a default mode and present a general menu of the most commonly used appliance functions determined for all users. Each menu 56-62 may further be provided with buttons (not shown) that allows a user to access the less commonly-used appliance functions.

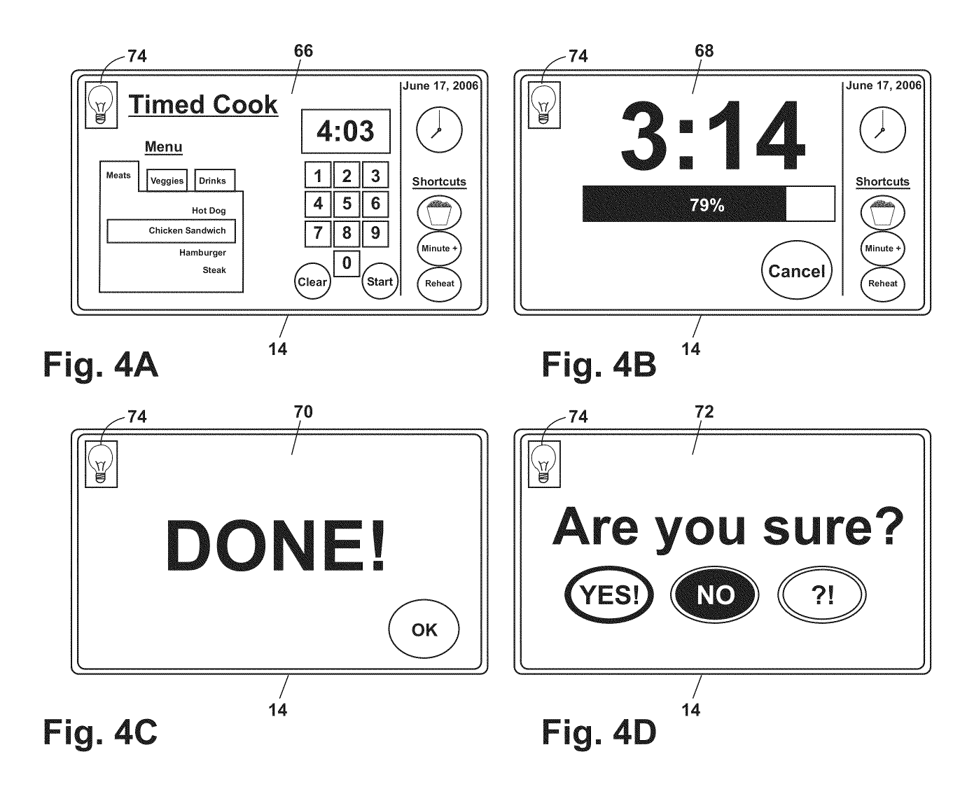

Referring to FIG. 4A-4D, an illustrative example of an adult user interface is presented. A user that is identified as an adult will initially be presented with an option menu 66, as shown in FIG. 4A. The option menu 66 comprises the general cooking operation that an adult typically performs. The adult option menu 66 is more sophisticated than the child option menu 56 and can comprise more complex functions. Other menus of the adult user-specific interface can be an progress menu 68 (FIG. 4B) that appears when the appliance 10 is in operation, an end menu 70 (FIG. 4C) that appears when the appliance 10 has completed an operation, and a confirmation menu 72 (FIG. 4D) that appears after the appliance 10 has completed an operation. The menus 66-72 can also be provided with a help button 74 that the user can press if the user has been assigned an incorrect user-specific interface because of an incorrect identification.

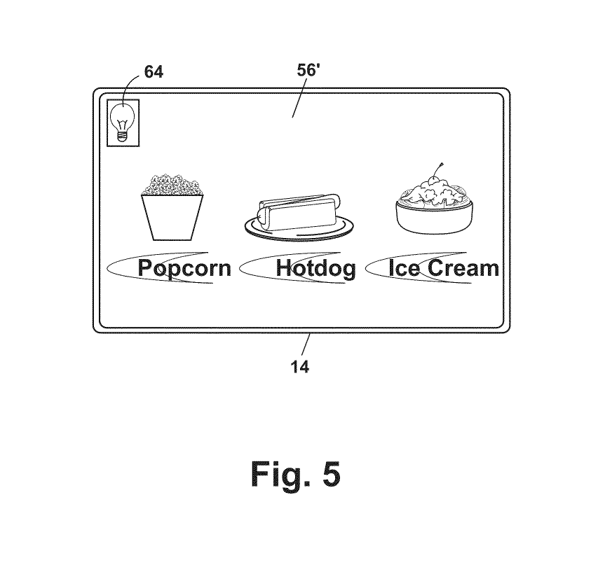

Referring to FIG. 5, an illustrative example of a refined child user interface is presented. When first operating the appliance 10, a user that is identified as a child will initially be presented with the option menu 56, as shown in FIG. 3A. Over time, if the child uses a function more often than the default functions of the standard child interface template, the preferred function will be added to a refined interface template to create a refined option menu 56′. As an example, the child may never use the pizza heating function, but may consistently use an ice cream warming function. Accordingly, the usage habits and user profile for the child are updated with this information each time the child uses the appliance 10 and eventually the refined child user interface will present an option menu 56′ with a one-touch button for warming ice cream in addition to or instead of the pizza heating button.

While the controller 12 has been described herein as storing information such as the biometric information, predetermined classes, and other information, it is understood that a separate storage device can be provided to serve in this capacity. In this embodiment, the storage device can be operably coupled to the controller 12 and the controller 12 can retrieve information from the storage device when needed. Furthermore, while illustrated as separate components of the appliance, the controller 12, user interface 14, and sensor 18 can be integrally formed in any combination.

While the invention has been specifically described in connection with certain specific embodiments thereof, it is to be understood that this is by way of illustration and not of limitation, and the scope of the appended claims should be construed as broadly as the prior art will permit.

What is claimed is:

1. A method for personalizing the operation of an appliance comprising a controller for controlling one or more functions of the appliance, a user interface operably coupled to the controller through which a user can select the one or more functions of the appliance, and at least one device that can detect a biometric characteristic of the user, the method comprising:
establishing multiple demographic classes of users based on a set of passively identifiable biometric characteristics;
establishing a standard interface template for each of the multiple demographic classes;
detecting the set of biometric characteristics of an unknown user using the at least one device;
matching the set of detected biometric characteristics to one of the multiple demographic classes;
assigning to the user the matched demographic class; and
displaying the standard interface template for the assigned demographic class on the user interface.

2. The method according to claim 1, wherein the standard interface templates comprise a subset of functions for the appliance.

3. The method according to claim 2, wherein the subset of functions for each standard interface template corresponds to the most commonly used functions of the appliance by users within the demographic class associated with the standard interface template.

4. The method according to claim 1, wherein each the demographic class is based on a unique set of demographic information.

5. The method according to claim 4, wherein the demographic information is at least one of age, gender, and language.

6. The method according to claim 5, wherein the multiple demographic classes comprise child, teen, adult, older adult, and unknown, and the corresponding established standard interface template comprises child, teen, adult, older adult, and unknown.

7. The method according to claim 1 and further comprising forming a user-specific interface for the user by customizing the displayed standard interface template.

8. The method according to claim 7, wherein the customizing comprises modifying the displayed standard interface template based on the user's operation of the appliance.

9. The method according to claim 8, wherein the user's operation of the appliance comprises the user's historical operation of the appliance.

10. The method according to claim 8, wherein customizing the user-specific interface comprises the user approving or rejecting the user-specific interface.

11. The method according to claim 1, wherein the standard interface templates are accessible by the controller.

12. The method according to claim 1, wherein the at least one device comprises at least one sensor, and the detecting comprises sensing the set of biometric characteristics.

13. The method according to claim 12, wherein the sensing comprises automatically sensing the set of biometric characteristics by at least one of a body dimension scan, scale, facial scan, voice scan, speech recognition, language recognition, finger pressure sensor, finger surface area sensor, infrared scanners, radar scanners, acoustic scanners, digital cameras, and heat sensors.

14. The method according to claim 1, wherein the set of universal biometric characteristics comprise at least two of height, weight, body mass, facial pattern, voice pattern, voice spectrum scan, speech pattern, language, handedness, finger pressure, finger size, and body temperature.
